(19) United States
(12) Patent Application Publication
(10) Pub. No.: US 2025/0053808 A1
(43) Pub. Date: Feb. 13, 2025

(54) METHOD, APPARATUS, ELECTRONIC DEVICE, AND STORAGE MEDIUM FOR DATA PROCESSING

(71) Applicant: Beijing Youzhuju Network Technology Co., Ltd., Beijing (CN)

(72) Inventors: Zaixiang ZHENG, Beijing (CN); Jiasheng YE, Beijing (CN); Yu BAO, Beijing (CN)

(21) Appl. No.: 18/797,228

(22) Filed: Aug. 7, 2024

(30) Foreign Application Priority Data
Aug. 8, 2023 (CN) 202310996726.4

(51) Int. Cl. G06N 3/08

(52) U.S. Cl. CPC G06N 3/08

(57) ABSTRACT

The embodiment of the disclosure provides a method, apparatus, electronic device, and storage medium for data processing. The method includes: receiving a corpus to be processed; obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and displaying the target prediction result. According to the technical solution of the embodiment of the disclosure, the effect of making the target diffusion language model can process the corpus data based on the principle of diffusion model and the obtained corpus data processing results can meet the requirements of corpus processing tasks is implemented.

### CROSS-REFERENCE TO RELATED APPLICATIONS

This application claims priority to Chinese Patent Application No. 202310996726.4, filed on Aug. 8, 2023, and entitled “A METHOD, APPARATUS, ELECTRONIC DEVICE, AND STORAGE MEDIUM FOR DATA PROCESSING”, the entirety of which is incorporated here by reference.

### FIELD

Embodiments of the present disclosure relate to the field of data processing technologies, and in particular, to a method, apparatus, electronic device, and storage medium for data processing.

### BACKGROUND

Currently, research related to the processing of corpus data with Artificial Intelligence (AI) has been gradually carried out. In this way, the processing requirements of users for corpus data are satisfied.

Usually, the autoregressive language model can be used to process the corpus data to get the corresponding corpus processing results.

However, since the autoregressive language model is obtained after large-scale unsupervised pre-training and downstream fine-tuning, the autoregressive language model may naturally suffer from the accumulation of errors and the lack of global vision in the process of continuous iterative training. As a result, it can lead to poor quality and low accuracy of corpus processing results, and the output corpus processing results from the model cannot meet the requirements of users.

### SUMMARY

The present disclosure provides a method, apparatus, electronic device, and storage medium for data processing, to implement the effect of making the target diffusion language model can process the corpus data based on the principle of diffusion model and the obtained corpus data processing results can meet the requirements of corpus processing tasks.

According to a first aspect, a method of data processing is provided by an embodiment of the present disclosure, including:
receiving a corpus to be processed;
obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
displaying the target prediction result

According to a second aspect, an apparatus for data processing is further provided by an embodiment of the present disclosure, including:
a corpus receiving module configured to receive a corpus to be processed;
a corpus processing module configured to obtain a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
a prediction result display module configured to display the target prediction result.

According to a third aspect, an electronic device is further provided by an embodiment of the present disclosure, including:
one or more processors; and
a storage device configured to store one or more programs which, when executed by the one or more processors, causes the one or more processors to implement a method of data processing according to the present disclosure.

According to a fourth aspect, a storage medium comprising computer-executable instructions is further provided by an embodiment of the present disclosure, wherein the computer-executable instructions, when executed by a computer processor, are configured to perform a method of data processing according to the present disclosure.

### BRIEF DESCRIPTION OF DRAWINGS

The above and other features, advantages, and aspects of various embodiments of the present disclosure will become more apparent from the following detailed description taken in conjunction with the accompanying drawings. Throughout the drawings, the same or similar reference numbers refer to the same or similar elements. It should be understood that the drawings are schematic, and items and elements are not necessarily drawn to scale.

FIG. 1 is a schematic flowchart of a method of data processing according to an embodiment of the present disclosure;

FIG. 2 is a schematic flowchart of a method of data processing according to an embodiment of the present disclosure;

FIG. 3 is a schematic flowchart of a method of data processing according to an embodiment of the present disclosure;

FIG. 4 is a schematic structural diagram of an apparatus for data processing according to an embodiment of the present disclosure; and

FIG. 5 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for example purposes only and are not intended to limit the scope of the present disclosure.

It should be understood that the steps recited in the method embodiments of the present disclosure may be performed in different orders, and/or in parallel. Further, the method embodiments may include additional steps and/or omit performing the illustrated steps. The scope of the present disclosure is not limited in this respect.

As used herein, the term “comprising” and deformation thereof are open-ended, i.e., “including but not limited to”. The term “based on” is “based at least in part on”. The term “one embodiment” means “at least one embodiment”; the term “another embodiment” means “at least one further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “one” and “a plurality” mentioned in this disclosure is illustrative and not limiting, and those skilled in the art should understand that “one or more” should be understood unless the context clearly indicates otherwise.

The names of messages or information interaction between a plurality of apparatuses in embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario and the like should be notified to the user in an appropriate manner according to the relevant laws and regulations and obtain the authorization of the user.

For example, in response to receiving an unsolicited request from the user, a prompt message is sent to the user to explicitly prompt the user that the requested operation will require access to and use of the personal information of the user. Thereby, the user is enabled to independently choose, based on the prompt information, whether or not to provide the personal information to software or hardware, such as an electronic device, an application, a server, or a storage medium, that performs the operation of the technical solution of the present disclosure.

As an optional but non-limiting implementation, in response to receiving an unsolicited request from the user, the manner of sending the prompt information to the user may be, for example, a pop-up window, in which the prompt information may be presented in the form of text. In addition, the pop-up window may contain an option control for the user to select “agree” or “disagree” to provide the personal information to the electronic device.

It is to be understood that the above notification and user authorization process is only illustrative and does not limit the implementation of the present disclosure, and other methods that satisfy the relevant laws and regulations may also be used in the implementation of the present disclosure.

It may be understood that the data involved in the technical solution (including but not limited to the data itself, the obtaining or use of the data) should follow the requirements of the corresponding laws and regulations and related regulations.

Before describing the present technical solution, application scenarios may be illustrated by way of example. The technical solution may be applied in a scenario in which a neural network-based model processes an input corpus in accordance with a corpus processing task corresponding to the input corpus to obtain a corpus processing result matching the corpus processing task. The technical solution provided by embodiments of the present disclosure uses a target diffusion language model in the network model. The target diffusion language model may be a diffusion model for processing corpus data, which may be a model constructed based on a pre-trained masked language, i.e., the pre-trained Masked Language Model (MLM) is used as a diffusion language model. Then, the masked language model is trained by a training method of the diffusion model, and the trained diffusion language model as the target diffusion language model. Thus, the effect of reducing the training cost and improving the training efficiency and the accuracy of the model is realized. Further, the target diffusion language model can be applied to a scene corresponding to any corpus processing task. For example, it may be applied in a scenario in which a review processing is performed on the input corpus. Wherein, the review processing may be to abstract the input article and abstract the results of the abstract as the results of the review of the article. In embodiments of the present disclosure, the article to be reviewed may be used as the corpus to be processed, and after obtaining the article to be reviewed, the article to be reviewed may be input into the target diffusion language model, and the abstracted generalization result corresponding to the article to be reviewed may be obtained.

Before describing the solution of the embodiments of the present disclosure, it is also noted that the target diffusion language model constructed based on the embodiments of the present disclosure may be deployed in a server or a client. Wherein, the server may be a service program that provides services and resources to the client and is targeted, and the device running the server is a server. Accordingly, the client is a program that corresponds to the server and provides local services to the user. Meanwhile, the client and the server can communicate with each other based on various forms of text transfer protocols, such as Hyper Text Transfer Protocol (HTTP). By way of example, the target diffusion language model in the embodiments of the present disclosure is integrated in an application software that supports various functions such as natural language processing or effects image processing, and the software may be installed in an electronic device. Optionally, the electronic device may be a mobile terminal or a PC, etc. The application software may be a class of software that processes data such as text, images, video or audio, and the specific application software thereof will not be repeated herein, as long as the processing of data such as text, images, video or audio can be implemented. It can also be a specially developed application program that is integrated in the corresponding software or, alternatively, in the corresponding page, so that the user can implement the processing of the relevant data through the integrated page in the PC.

According to the technical solution of the embodiment of the disclosure, a corpus to be processed is received, a target prediction result corresponding to the corpus to be processed is obtained by processing the corpus to be processed based on a target diffusion language model, thus the effect of diffusion-based modelling on corpus data is implemented. Finally, the target prediction result is displayed. It solves the problems of poor quality of corpus processing results, low accuracy rate, and failure to meet the requirements of users, etc., which existed when the autoregressive language model was used to process corpus data in the related technology. Further, it achieves the effect that the target diffusion language model can be based on the principle of the diffusion model to process the corpus data and the obtained corpus data processing results can meet the requirements of the corpus processing task, thus improving the accuracy rate of the corpus data processing results and enhancing the user experience.

FIG. 1 is a schematic flowchart of a method of data processing according to an embodiment of the present disclosure.

As shown in FIG. 1, the method in this embodiment may specifically include as follows.

At S110, a corpus to be processed is received.

In some embodiments, the corpus to be processed may be understood as a corpus to be subjected to corpus processing. In this embodiment, the corpus to be processed may be a corpus in the form of text. In practical applications, the corpus to be processed may correspond to a corpus processing task. By way of example, if the corpus processing task is a text translation task, the corpus to be processed may be a corpus comprising the text to be translated; if the corpus processing task is an article review task, the corpus to be processed may be a corpus comprising the article to be reviewed; if the corpus processing task is an article abstract task, the corpus to be processed may be a corpus comprising the article to be abstracted.

In this embodiment, the corpus to be processed may be the corpus input by the user in real time through an input device (e.g., a keyboard, etc.) on the mobile terminal; alternatively, it is the corpus uploaded to the corresponding server through the application software; or alternatively, it may be the corpus stored in advance in the storage space of the device. In practice, for the application software that provides natural language processing functions to the user, each part of the corpus obtained after the service performing segmentation processing on the received corpus data can also be used as the corpus to be processed, and the embodiments of the present disclosure do not make specific limitations in this regard.

In practice, in order to be able to identify the corpus processing task corresponding to the corpus to be processed, the corpus to be processed may be made to carry an identification characterizing the corresponding corpus processing task. Thus, the corpus processing task corresponding to the corpus to be processed may be determined based on the corresponding identification. Thereby, a corpus processing result corresponding to the corpus processing task may be determined.

Based on this, before receiving the corpus to be processed, it further comprises: editing an original corpus; and obtaining the corpus to be processed by marking a task identification for the original corpus, to cause the target diffusion language model to process the corpus to be processed based on the task identification.

In some embodiments, the original corpus may be a captured, unprocessed corpus. The language type of the original corpus may be any type. Optionally, the language type of the original corpus may be English, and accordingly, the original corpus may be an English text. By way of example, the original corpus may be a sentence of English text, such as, “Diffusion language models can be so cool”. It is noted that the original corpus may be in any of a number of forms. Optionally, the form of the original corpus may be in the form of text, in the form of audio, in the form of video, and so on.

In some embodiments, the original corpus may be the corpus input by the user in real time through the input device on the mobile terminal; or it may be the corpus uploaded to the server through the application software; or it may be the corpus stored in the pre-constructed-to corpus library. In practice, for the application software that provides natural language processing functions to the user, each part of the corpus obtained after the service performs segmentation processing on the received corpus data can also be used as the original corpus, and the embodiments of the present disclosure do not make specific limitations in this regard. In practical applications, editing the original corpus may include a variety of ways, and the following editing ways of the original corpus may be described separately.

A first way may be: displaying at least one corpus to be selected; in response to a selection trigger operation for the at least one corpus to be selected, determining the original corpus.

In some embodiments, the corpus to be selected may be one or more than one corpus. The corpus to be selected may be a corpus pre-stored in a corpus library. In practice, at least one corpus to be selected may be displayed in the display interface, and the user may select among the displayed corpus to be selected by the trigger operation. In the case where a selection trigger operation is detected for any of the corpus to be selected, the selection trigger operation is responded to and the currently selected corpus to be selected is used as the original corpus.

The second way may be: in response to a corpus input operation, obtaining an original corpus.

In some embodiments, the corpus input operation may be understood as an operation of inputting the corpus based on the input device. In practice, the input can be performed on the corpus based on the input device, and thus, the input corpus can be used as the original corpus when the input completion trigger operation is detected.

It should be noted that since the corpus to be processed is a corpus in the form of text, the original corpus may be a corpus of any form. Therefore, after obtaining the original corpus, in the case where the obtained original corpus is a corpus of a form other than the text form, a form conversion process may be performed on the obtained original corpus to convert the obtained original corpus into a corpus of the text form. Further, the converted corpus may be subjected to a task identification marking process. Thereby, the corpus to be processed may be obtained.

In some embodiments, a task identification may be understood as an identification characterizing a corpus processing task. A corpus processing task may be understood as a task that processes the input corpus to obtain a corresponding corpus processing result. Optionally, the corpus processing task may include a translation task, an abstract task, a review task, and an error identification task, among others. Optionally, the task identification may be a predetermined number corresponding to the corpus processing task for each task type. In practice, for each corpus processing task, a number corresponding to the corpus processing task of each task type may be predetermined. Further, a mapping relationship between the task types and the numbering may be established. Thereby, a task identification may be marked for the original corpus based on the pre-established mapping relationship. Alternatively, the task identification may be a predetermined keyword or keyphrase corresponding to the corpus processing task for each task type. In practice, for each task type of the corpus processing task, keywords or keyphrases that can characterize the task type of the corpus processing task may be predetermined based on the processing way or other data of the corpus processing task, and the determined keywords or keyphrases may be used as task identification corresponding to the task type. Further, the task identification may be marked for the original corpus based on the predetermined keywords or keyphrases. For example, the original corpus is Diffusion language models can be so cool that the corpus processing task corresponding to the original corpus is a translation task. The task identification corresponding to the translation task can be a keyword. For example, the keyword can be “Translate”. Further, the corpus to be processed after marking the task identification for the original corpus can be Translate “Diffusion language models can be so cool” Answer in Chinese.

In practical applications, the original corpus can be obtained by editing the corpus. Further, a corpus processing task corresponding to the original corpus may be determined. Further, a task identification may be marked for the original corpus based on the corpus processing task corresponding to the original corpus. Further, the original corpus that has been marked with the task identification may be taken as the corpus to be processed so that the target diffusion language model may process the corpus to be processed based on the language identification. The advantage of such a setting is that the target diffusion language model can be made to process the corpus to be processed according to the type of task corresponding to the corpus to be processed, so as to ensure that the target prediction results obtained can meet the corpus processing requirements.

At S120, a target prediction result corresponding to the corpus to be processed is obtained by processing the corpus to be processed based on a target diffusion language model.

In some embodiments, the target diffusion language model can be understood as a diffusion model that uses the corpus data as an input object in order to process the corpus data. A person skilled in the art may understand that Diffusion Models are a generative model based on iterative denoising. Diffusion models can be classified into continuous diffusion models and discrete diffusion models based on the type of data distribution they model. For the generation process of image and audio, since both image and audio belong to the continuous type of data, the continuous diffusion model can be used to process the input image or input audio to determine the generation results. The quality of its generation results is significantly higher than other generation models. For the text generation process, since text belongs to the discrete type of data, the discrete diffusion model can be used to process the input text to determine the generation results. However, the model construction cost of the discrete diffusion model is high, and at the same time, the training target of the discrete diffusion model is consistent with the training target of the masked language model. Therefore, the pre-trained masked language model can be used as the diffusion language model, and the masked language model can be trained based on the corresponding corpus samples of the diffusion language model to obtain the target diffusion language model. It should be noted that using the trained masked language model as the diffusion language model reduces the model construction cost of the target diffusion language model.

In some embodiments, the Masked Language Model (MLM) may be a language model for performing natural language processing tasks. The masked language model may process a corpus that includes a corpus that has been masked in order to make predictions about the mask corpus data in the corpus. Specifically, a portion of words in the input corpus of the model is randomly selected at a certain mask rate, and the selected portion of words is masked. Afterwards, the processed corpus may be input into the trained masked language model for processing, and a prediction result may be obtained, which may be a prediction result corresponding to the masked words in the corpus.

In this embodiment, the target diffusion language model may be obtained by training based on a plurality of corpus samples. The mask corpus in the corpus samples corresponds to different mask rates. Wherein, the corpus samples may include unmasked corpus as well as corresponding mask corpus. A mask corpus may be understood as a corpus obtained by masking at least part of the data in the corpus. A mask rate may be understood as a percentage between the amount of data masked in a corpus and the total amount of data in the corpus. By way of example, assuming that a corpus includes 10 words, a mask corpus is obtained after masking any two words in the corpus. The mask rate corresponding to this mask corpus may be 20%. It should be noted that the number of mask rates corresponding to the mask corpus in the corpus sample and the value corresponding to each mask rate are randomly determined, i.e., the starting point of the value corresponding to the mask rate as well as the step size between each mask rate are randomly sampled and determined in an interval of 0-1.

In practical applications, a plurality of unmasked processed training corpus can be obtained. Afterwards, the obtained plurality of training corpus can be processed according to different mask rates to obtain a mask corpus corresponding to the training corpus. Further, the training corpus and the corresponding mask corpus may be taken as one corpus sample, and a plurality of corpus samples may be obtained. Further, the diffusion language model to be trained may be trained based on the constructed plurality of corpus samples. Thereby, a trained target diffusion language model can be obtained. It is to be noted that training the masked language model using corpus samples with different mask rates may be to apply the training way of the diffusion model to the masked language model in order to activate the generative ability of the masked language model. Thereby, improving the adaptability of the target diffusion language model for the downstream application task.

It is noted that the target diffusion language model may be a single-task type processing model or a multi-task type processing model. Wherein, the single-task type processing model may be a model that is only used to process a specific single corpus processing task. Accordingly, the multi-task type processing model may be a model capable of processing multiple types of corpus processing tasks.

In the case where the target diffusion language model is a single-task type processing model, the corpus to be processed input into the target diffusion language model may correspond to a corpus processing task of the same task type. Furthermore, the corpus processing task corresponds to the corpus processing task corresponding to the target diffusion language model. In the process of practical application, after obtaining the corpus to be processed, the corpus to be processed can be input into the target diffusion language model, and the corpus to be processed can be processed based on the target diffusion language model. Thereby, a corpus prediction result corresponding to the corpus to be processed can be output.

In the case where the target diffusion language model is a multi-task type model, after obtaining the corpus to be processed, the corpus to be processed may be input into the target diffusion language model. Further, a task type corresponding to the corpus to be processed may be determined based on the target diffusion language model. Further, the corpus to be processed may be processed according to the corresponding task type based on the target diffusion language model. Thereby, a result of processing the corpus corresponding to the task type may be obtained.

In practical applications, after obtaining the corpus to be processed, the corpus to be processed may be input into the target diffusion language model. Further, the corpus to be processed may be processed based on the target diffusion language model. Thereby, a target prediction result corresponding to the corpus to be processed may be obtained.

In some embodiments, the target prediction result may be a prediction result obtained after the target diffusion language model processes the corpus to be processed in accordance with a corpus processing task corresponding to the corpus to be processed. Optionally, the target prediction result may include any of a translation result, an abstract result, a review result, and an error identification result corresponding to the corpus to be processed. By way of example, if the corpus processing task corresponding to the corpus to be processed is a text translation task of translating an English text into a Chinese text, and the corpus to be processed is a sentence of an English text to be translated, then the target prediction result may be a Chinese text corresponding to the English text that has been translated; and if the corpus processing task corresponding to the corpus to be processed is a task of determining an abstract of an entire article, and the corpus to be processed is an article to be processed, then the target prediction result may be an article corresponding to the article; if the corpus processing task corresponding to the corpus to be processed is the task of identifying the review of the entire article, and the corpus to be processed is a paragraph of text to be processed, the target prediction result can be the text review corresponding to the paragraph; if the corpus processing task corresponding to the corpus to be processed is the task of identifying the incorrect words and phrases, and the corpus to be processed is a paragraph of text to be recognized, the target prediction result can be the incorrect phrase identification result.

At step S130, the target prediction result is displayed.

In a practical application, the target prediction results can be displayed in the case where the target prediction results are obtained. Thereby, the target prediction results corresponding to the corpus to be processed may be displayed on a target display interface. Wherein, the target display interface may be predetermined for displaying a display interface for displaying the corpus prediction results.

In practical application, for different application scenarios, the display position of the target prediction result may also change correspondingly. By way of example, for a corpus translation scenario integrated in a web page, the display interface may include two display areas at the same time, wherein one of the display areas may be a reception area of the corpus to be processed, and the other display area may be a display area of the target prediction result. In the case where a corpus reception operation is detected against the reception area of the corpus to be processed, the corpus to be processed may be received. Further, in the case of detecting a trigger operation against the corpus translation control, a response is made to the trigger operation, and a translation result corresponding to the corpus to be processed is displayed in the display area of the target prediction result. Alternatively, for the video playing scenario, the target video can be played in the display interface, and when the trigger operation for the line translation control is detected, the translation results corresponding to the original lines of the video can be synchronously displayed in the display interface, and at this time, the display area of the target prediction results is the video playing interface. Alternatively, for a scenario in which review processing is performed on the content of a conference, conference audio data or conference text data may be received based on a terminal device that pre-deploys the target diffusion language model. Furthermore, in the event that a trigger operation is detected for the review processing control, a response may be made to the trigger operation, and the corresponding conference review may be displayed in the display interface of the terminal device.

According to the technical solution provided by the embodiment of the disclosure, the corpus to be processed is received; further, a target prediction result corresponding to the corpus to be processed is obtained by processing the corpus to be processed based on a target diffusion language model, implementing the effect of processing the corpus data based on diffusion model; finally, displaying the target prediction result. It solves the problems of poor quality of corpus generation results, low accuracy rate, and corpus generation results not meeting the requirements of the users, etc., which exist in the related technologies when the autoregressive language model is used to process corpus data, implements the effect that the target diffusion language model can be used to process corpus data based on the principle of the diffusion model. The results obtained can meet the requirements of the corpus processing task, improves the accuracy rate of the corpus data processing results, and improves the experience of the users. The accuracy of the corpus data processing results is improved, and the user experience is enhanced.

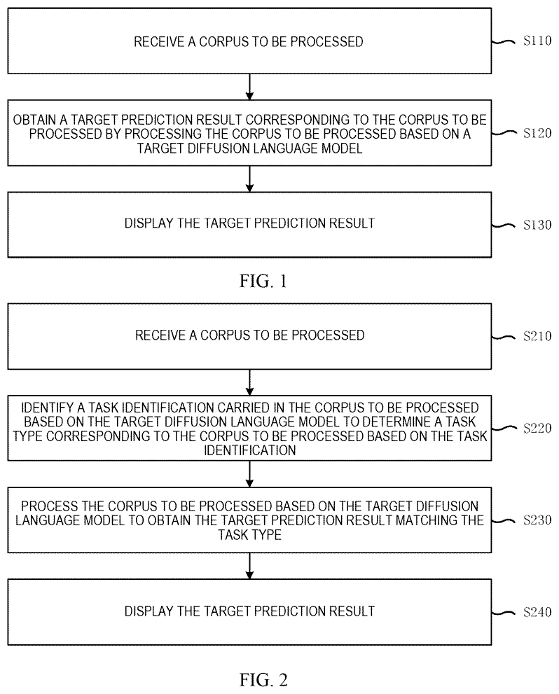

FIG. 2 is a schematic flowchart of a further method of data processing according to an embodiment of the present disclosure. The technical solution of the present embodiment, on the basis of the above embodiment, provides further refinement on how to process the corpus to be processed based on the target diffusion language model when the target diffusion language model is a multi-task type processing model. Specific embodiments can be found in the description of this embodiment. Technical features that are the same or similar to the foregoing embodiments are not repeated herein.

As shown in FIG. 2, the method in this embodiment may specifically include as follows.

At S210, a corpus to be processed is received.

At S220, a task identification carried in the corpus to be processed is identified based on the target diffusion language model to determine a task type corresponding to the corpus to be processed based on the task identification.

In some embodiments, the task type may be understood as a type of corpus processing task to be processed. Optionally, the task type may include a text translation task, an article abstract task, a text review task, and an error text identification task. In the actual application process, the task types of a plurality of corpus processing tasks may be predetermined. Further, for each task type, a task identification corresponding to the task type can be set in advance, and a task identification corresponding to each determined task type can be determined. Afterwards, a mapping relationship between the task type and the task identification can be established and the mapping relationship can be deployed in the target diffusion language model.

In practice, in the case where the target diffusion language model is a multi-task type processing model, after inputting the corpus to be processed into the target diffusion language model, the task identification carried in the corpus to be processed may be identified based on the target diffusion language model to determine the task identification carried in the corpus to be processed. Further, a task type corresponding to the corpus to be processed may be determined based on the mapping relationship pre-deployed in the target diffusion language model and the identified task identification. Thereby, the corpus to be processed may be processed according to the corpus processing task corresponding to the task type.

At S230, the corpus to be processed is processed based on the target diffusion language model to obtain the target prediction result matching the task type.

In this embodiment, after determining a task type corresponding to the material to be processed, the corpus to be processed may be processed based on a target diffusion language model in accordance with a corpus processing task corresponding to the determined task type. Thereby, a target prediction result matching the task type may be obtained.

Optionally, if the task type corresponding to the corpus to be processed is a text translation type, the target prediction result may be a translation result corresponding to the corpus to be processed; if the task type corresponding to the corpus to be processed is an article abstract type, the target prediction result may be an abstract result corresponding to the corpus to be processed; if the task type corresponding to the corpus to be processed is a text review type, the target prediction result may be a review result corresponding to the corpus to be processed; if the task type corresponding to the corpus to be processed is a text error identification type, the target prediction result may be an error identification result corresponding to the corpus to be processed.

It should be noted that if the target diffusion language model is a single-task type processing model, the target diffusion language model is trained based on the single-task type training samples. The target diffusion language model may be used to perform only single-task type corpus processing tasks. In such a case, after inputting the corpus to be processed into the target diffusion language model, the corpus to be processed may be directly processed. In turn, a target prediction corresponding to the corpus to be processed may be obtained.

At S240, the target prediction result is displayed.

The technical solution of an embodiment of the present disclosure, by receiving a corpus to be processed, and thereby, identifying a task identification carried in the corpus to be processed based on the target diffusion language model to determine a task type corresponding to the corpus to be processed based on the task identification, and thereafter, processing the corpus to be processed based on the target diffusion language model to obtain the target prediction result matching the task type. Finally, displaying the target prediction results, implementing the effect of making the target diffusion language model process the corpus according to the task type corresponding to the corpus, displaying the multi-task type processing capability and flexibility of the model, improving the adaptability of the model for multi-task types, and enhancing the experience of the user.

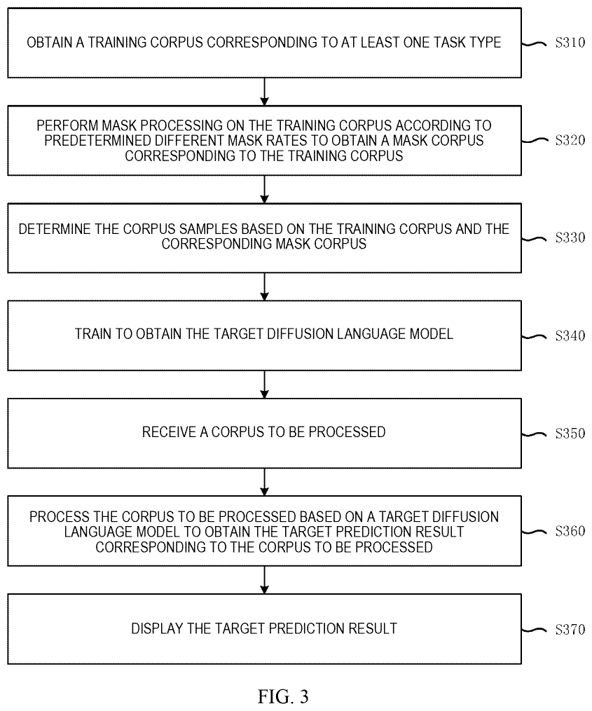

FIG. 3 is a schematic flowchart of a method of data processing according to an embodiment of the present disclosure. The technical solution of the present embodiment, on the basis of the above embodiments, before processing the corpus to be processed based on the target diffusion language model, the training corpus corresponding to different task types may be obtained, and the training corpus may be masked based on predetermined different masking rates, so as to obtain the mask corpus of the training corpus under different mask rates. Thus, based on the training corpus and the corresponding mask corpus, the corpus samples may be constructed. Whereby the diffusion language model can be trained based on the corpus samples to obtain a target diffusion language model. Specific implementations can be found in the description of the present embodiment. Herein, technical features that are the same or similar to the preceding embodiments are not repeated herein.

As shown in FIG. 3, the method in this embodiment may specifically include as follows.

At S310, a training corpus corresponding to at least one task type is obtained.

In some embodiments, the training corpus may be understood as a sample corpus for performing a training process. Similar to the corpus to be processed, the training corpus may be a sample corpus in the form of text. In this embodiment, the training corpus may be a corpus input by an input device; or a corpus pre-stored in a corpus library; or, a corpus segmented by a corpus segmentation model, etc. It should be noted that for different types of tasks, the corresponding training corpus may be the same or different, and the embodiments of the present disclosure do not specifically limit this. It is also noted that the task types corresponding to the obtained training corpus may be one or more, and the kinds of task types corresponding to the training corpus may match the types of the diffusion language model to be trained. In the case where the diffusion language model to be trained is a single-task-type processing model, the kind of task type corresponding to the obtained training corpus may be one, whereby the trained target diffusion language model may be made to perform a corpus processing task of a specific task type. In the case where the diffusion language model to be trained is a multi-task-type processing model, the kind of task type corresponding to the obtained training corpus may be multiple. Thus, the trained target diffusion language model may be applicable to the multi-task type corpus processing task.

In practice, prior to training a diffusion language model to be trained, a plurality of corpus samples need to be pre-constructed to train the model based on the corpus samples. In order to improve the accuracy of the model, the corpus samples may be constructed as many and as rich as possible. Specifically, a corpus processing task of at least one task type to be performed by the target diffusion language model may be determined. Further, a corresponding training corpus under the corresponding task type may be obtained based on the determined task type. Thereby, the corpus sample may be constructed based on the obtained training corpus.

At S320, mask processing is performed on the training corpus according to predetermined different mask rates to obtain a mask corpus corresponding to the training corpus.

In some embodiments, the mask rate can be understood as a percentage between the amount of data masked in a corpus and the total amount of data in that corpus. In this embodiment, the pre-set different mask rates may be mask rates obtained by random sampling from between 0-1. That is, the number of mask rates and the value corresponding to each mask rate are randomly determined. The advantage of using the training corpus without using mask rates to construct the corpus samples is that the training target of the target diffusion language model can be determined as the full mask rate, which improves the processing capability of the target diffusion language model for the corpus with different mask rates and improves the scalability of the model.

It should be noted that a mask processing of the training corpus based on different mask rates to construct corpus samples can be understood as a process of constructing training samples based on the training method of the diffusion model. Specifically, for a diffusion model that performs an image generation task, the corresponding training process may be a process of iteratively adding image noise, assuming that the original image is a real image, and image noise is added to the image by accumulating a number of times, in which the aggregation of the process is such that, as the number of times increases, the obtained image is getting closer and closer to pure noise. Further, image samples for training the diffusion model can be constructed based on the images obtained in the above process to complete the training of the diffusion model. For the diffusion model for performing a corpus processing task mentioned in the embodiments of the present disclosure, a way of masking the training corpus based on different mask rates may be used to construct a corpus sample for training the diffusion model. Thus, the diffusion model may be trained based on the constructed corpus sample to obtain a target diffusion language model that can perform a corpus processing task.

In practical applications, after obtaining the training corpus corresponding to at least one task type, for the training corpus corresponding to each task type, the training corpus may be masked according to pre-set different mask rates. Further, a mask corpus under different mask rates corresponding to the training corpus may be obtained. It is to be noted that the number of mask corpus corresponding to the training corpus corresponds to the number of mask rates at which the training corpus is processed. It is further noted that the number of mask rates corresponding to different training corpus and the values corresponding to each mask rate may be the same or different, and the embodiments of the present disclosure do not specifically limit this.

At S330, the corpus samples are determined based on the training corpus and the corresponding mask corpus.

Herein, the corpus sample is a training sample required for training the diffusion language model to be trained.

In practical applications, after obtaining a training corpus and a mask corpus corresponding to the training corpus, a corpus sample may be constructed based on the training corpus with its corresponding mask corpus. Each corpus sample may include the training corpus and the mask corpus at different mask rates corresponding to the training corpus.

It is to be noted that if the target diffusion language model is a multi-task type processing model, in order to enable the trained target diffusion language model to identify the task identification corresponding to the input corpus of the model, the task identification can be added to the corpus samples during the training process of the model, so as to train the model on the basis of the corpus samples to which the task identification is added. Thereby, the target diffusion language model can be made capable of identifying the task identification of the model input corpus.

Based on this, on the basis of each of the above technical solutions, it is further comprised: if the target diffusion language model is a multi-task type processing model, marking a corresponding task identification for the corpus sample to update the corpus sample.

Herein, the task identification matches the task type.

In practice, if a model training goal is to obtain a target diffusion language model for a multi-task type processing model. After determining the plurality of corpus samples, a corresponding task identification can be determined based on the task types corresponding to the training corpus in the corpus samples, and the corpus samples can be marked with the corresponding task identification. Thereby, the corpus sample may be updated based on the corpus sample after marking. The benefits of such a setup are that the adaptability of the target diffusion language model for multi-task type corpus processing tasks is improved, and the scalability of the target diffusion language model is enhanced.

At S340, it is trained to obtain the target diffusion language model.

In the present embodiment, after determining the corpus sample, the model to be trained can be trained based on the corpus sample. Thereby, a target diffusion language model can be obtained.

In practical applications, among the various types of models that can process corpus data, the training target of the discrete diffusion language model is consistent with that of the masked language model, both of which process the corpus data based on the trained language model in order to obtain the corpus processing results corresponding to the corpus data. Meanwhile, the mask rate used in the training process of masked language model can correspond to the noise used in the training process of diffusion model. As the training process of the discrete diffusion model is cumbersome and the training cost is high in the process of practical application, at the same time, the research and application in the field of model construction of masked language model is relatively sufficient, i.e., the trained masked language model is relatively easy to obtain. Therefore, in order to be able to reduce the training cost of the diffusion model and to improve the training efficiency of the diffusion model, the trained masked language model can be used as the diffusion language model to be trained. Further, in the case of training the diffusion language model to be trained, the model parameters of the masked language model can be adjusted based on the constructed corpus samples. Thereby, the masked language model with adjusted parameters can be used as the trained target diffusion language model.

Optionally, the training to obtain the target diffusion language model comprises: obtaining a pre-trained masked language model; and training the masked language model based on the corpus samples to obtain the target diffusion language model.

In some embodiments, the pre-trained masked language model may be understood to be a trained masked language model. It will be understood by those skilled in the art that a masked language model (MLM) may be a language model for performing natural language processing tasks. The masked language model may process a corpus that has been masked to make predictions about the mask corpus data in the corpus. Specifically, a portion of words in the input corpus of the model is randomly selected at a certain mask rate, and the selected portion of words is performed the masking process. Afterwards, the processed corpus may be input into the trained masked language model for processing, and a prediction result may be obtained, which may be a prediction result corresponding to the masked words in the corpus.

It should be noted that the masked language model is obtained after training based on a training target with a fixed mask rate. However, the target diffusion language model is trained with a full mask rate (randomly sampled from between 0-1). The masked language model still lacks in language generation capability, which is insufficient for downstream application tasks. Therefore, after obtaining the masked language model, the masked language model can be trained based on the constructed corpus samples, so that the trained target diffusion language model can be adaptable to downstream application tasks.

In practical applications, a masked language model that has completed a pre-training phase may first be obtained. Further, the masked language model may be trained based on the constructed language samples to adjust the parameters of the masked language model. Thereby, a target diffusion language model can be obtained. The advantage of such a setting is that the use of the trained masked language model as the diffusion language model to be trained reduces the training cost of the target diffusion language model. Thus, after the masked language model is trained by the corpus samples, the adaptability of the target diffusion language model for the downstream application task is improved.

Optionally, training the masked language model based on the corpus samples to obtain the target diffusion language model comprises: inputting the training corpus in the corpus samples into the masked language model to obtain an actual output corpus; determining a loss value based on the actual output corpus and the corresponding mask corpus; and adjusting model parameters in the masked language model based on the loss value with a training goal of convergence of a loss function in the masked language model, to obtain the target diffusion language model.

It should be noted that, for each corpus sample, the corpus sample may be trained in the foregoing way, to obtain the target diffusion language model.

In some embodiments, the actual output corpus may be a corpus prediction result output after inputting the training corpus to the masked language model, and the corpus prediction result matches a task type of the training corpus. The loss value may be understood as a difference value between the actual output corpus and the corresponding mask corpus. The loss function may be a function determined based on the loss value for characterizing the degree of difference between the actual output and the theoretical output.

In practice, after obtaining the masked language model, for each corpus sample, a training corpus in the corpus sample may be input into the masked language model to process the training corpus based on the masked language model to obtain an actual output corpus corresponding to the training corpus. Further, this actual output corpus may be compared to the mask corpus in the current corpus sample to determine a loss value. Further, the model parameters in the masked language model may be adjusted based on the loss value. Afterwards, the training error of the loss function in the masked language model, i.e., the loss parameter, may be used as a condition for detecting whether or not the current loss function reaches convergence. For example, whether or not the training error is smaller than a predetermined error or whether or not the trend of the change in the error tends to be stabilized, or whether or not the current number of iterations of the model is equal to the predetermined number of iterations, and the like. If it is detected that the convergence conditions are reached, for example, the training error of the loss function is smaller than the predetermined error or the error change tends to stabilize, it indicates that the current masked language model training is completed, and then the iterative training can be stopped. If it is detected that the current convergence conditions have not been reached, the masked language model can be further trained by obtaining the current training samples until the training error of the loss function is within the predetermined range. When the training error of the loss function reaches convergence, the masked language model obtained from the current training can be used as the target diffusion language model. The benefits of such a setup are: on the basis of improving the model accuracy and task matching, it reduces the training cost of the model, implements the effect of activating the generative ability of the masked language model by using the diffusion model. In turn, it can make the target diffusion language model a large-scale language model constructed based on the theoretical framework of the diffusion model.

At S350, a corpus to be processed is received.

At S360, the corpus to be processed is processed based on a target diffusion language model to obtain the target prediction result corresponding to the corpus to be processed.

At S370, the target prediction result is displayed.

It is to be noted that after obtaining the trained target diffusion language model, the input corpus to be processed can be processed based on the target diffusion language mode. Tus, a corpus processing result corresponding to the corpus to be processed can be obtained, and the corpus processing result matches the task type corresponding to the corpus to be processed. The specific processing of the target diffusion language model for processing the corpus to be processed can be seen as described in steps S110-S130.

The technical solution of an embodiment of the present disclosure, by obtaining a training corpus corresponding under at least one task type, after which a mask corpus corresponding to the training corpus is obtained by performing masking processing on the training corpus based on pre-set different masking rates. Then, based on the training corpus and the corresponding mask corpus, the corpus samples are determined, and a target diffusion language model is trained. Afterwards, the target diffusion language model is processed based on the target diffusion language model for the corpus to be processed to obtain the target prediction results corresponding to the corpus to be processed. Finally, the target prediction results are displayed. This implements the effect of training the masked language model using the model training target with full mask rate to adapt the target diffusion language model to the downstream application tasks, enhancing the generalizability, versatility and practicability of the model. In turn, improves the prediction accuracy of the models for the input corpus and the task type matching of the prediction results.

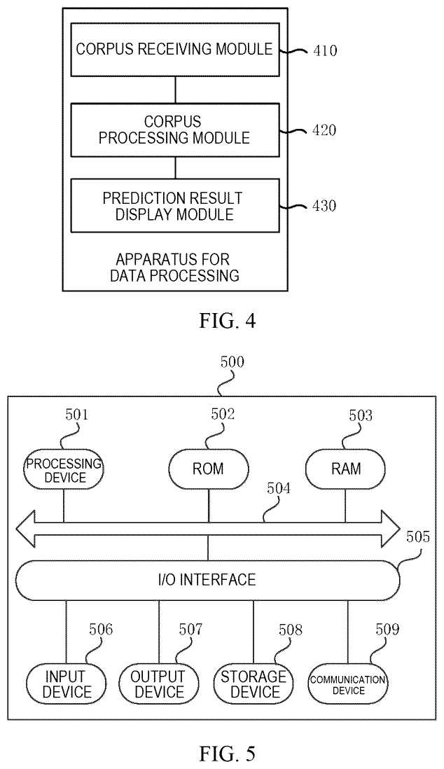

FIG. 4 is a schematic structural diagram of an apparatus for data processing according to an embodiment of the present disclosure. As shown in FIG. 4, the apparatus comprises: a corpus receiving module 410, a corpus processing module 420, and a prediction result display module 430.

Herein, the corpus receiving module 410 is configured to receive a corpus to be processed; the corpus processing module 420 is configured to obtain a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and the prediction result display module 430 is configured to display the target prediction result.

On the basis of the above technical solutions, the apparatus further includes: a corpus editing module and a corpus marking module.

The corpus editing module is configured to edit an original corpus before receiving the corpus to be processed.

The corpus marking module is configured to obtain the corpus to be processed by marking a task identification for the original corpus, to cause the target diffusion language model to process the corpus to be processed based on the task identification.

Based on the foregoing technical solutions, the target diffusion language model is a multi-task type processing model, and the corpus processing module 420 includes: an identification identifying unit and a corpus processing unit.

The identification identifying unit is configured to identify a task identification carried in the corpus to be processed based on the target diffusion language model to determine a task type corresponding to the corpus to be processed based on the task identification.

The corpus processing unit is configured to process the corpus to be processed based on the target diffusion language model to obtain the target prediction result matching the task type.

Based on the foregoing technical solutions, the apparatus further includes: a training corpus obtaining module, a mask corpus determining module, and a corpus sample determining module.

The training corpus obtaining module is configured to obtain a training corpus corresponding to at least one task type.

The mask corpus determining module is configured to perform mask processing on the training corpus according to predetermined different mask rates to obtain a mask corpus corresponding to the training corpus.

The corpus sample determining module is configured to determine the corpus samples based on the training corpus and the corresponding mask corpus.

On the basis of the above technical solutions, the apparatus further includes: a corpus sample updating module.

The corpus sample updating module is configured to, in response to the target diffusion language model being a multi-task type processing model, mark a corresponding task identification for the corpus sample to update the corpus sample.

Herein, the task identification matches the task type.

Based on the foregoing technical solutions, the apparatus further includes: a model training module.

The model training module is configured to train to obtain the target diffusion language model after obtaining the corpus sample.

The model training module comprises: a model obtaining unit and a model training unit.

The model obtaining unit is configured to obtain a pre-trained masked language model.

The model training unit is configured to train the masked language model based on the corpus samples to obtain the target diffusion language model.

Based on the foregoing technical solutions, the model training unit includes: a corpus input subunit, a loss value determining subunit, and a model parameter adjusting subunit.

The corpus input subunit is configured to input the training corpus in the corpus samples into the masked language model to obtain an actual output corpus.

The loss value determining subunit is configured to determine a loss value based on the actual output corpus and the corresponding mask corpus.

The model parameter adjusting subunit is configured to adjust model parameters in the masked language model based on the loss value with a training goal of convergence of a loss function in the masked language model, to obtain the target diffusion language model.

Based on the foregoing technical solutions, the target prediction result comprises any of a translation result, an abstract result, a review result, or an error identification result corresponding to the corpus to be processed.

According to the technical solution provided by the embodiment of the disclosure, the corpus to be processed is received; further, a target prediction result corresponding to the corpus to be processed is obtained by processing the corpus to be processed based on a target diffusion language model, implementing the effect of processing the corpus data based on diffusion model; finally, displaying the target prediction result. It solves the problems of poor quality of corpus generation results, low accuracy rate, and corpus generation results not meeting the requirements of the users, etc., which exist in the related technologies when the autoregressive language model is used to process corpus data, implements the effect that the target diffusion language model can be used to process corpus data based on the principle of the diffusion model. The results obtained can meet the requirements of the corpus processing task, improves the accuracy rate of the corpus data processing results, and improves the experience of the users. The accuracy of the corpus data processing results is improved, and the user experience is enhanced.

The apparatus for data processing provided in the embodiments of the present disclosure may perform the method of data processing provided by any embodiment of the present disclosure and has functional modules and beneficial effects corresponding to the execution method.

It should be noted that the various units and modules included in the above-described apparatus are only divided in accordance with the functional logic but are not limited to the above-described division, as long as they are capable of implementing the corresponding functions. Furthermore, the specific names of the various functional units are only for the purpose of facilitating mutual differentiation, and are not used to limit the scope of protection of the embodiments of the present disclosure.

FIG. 5 is a schematic structural diagram of an electronic device according to an embodiment of the present disclosure. Reference is made below to FIG. 5, which illustrates a schematic diagram of a structure of an electronic device (e.g., a terminal device or a server in FIG. 5) 500 suitable for use in implementing embodiments of the present disclosure. Terminal devices in embodiments of the present disclosure may include, but are not limited to, mobile terminals such as mobile phones, laptop computers, digital broadcast receivers, PDAs (personal digital assistants), PADs (tablet computers), PMPs (portable multimedia players), in-vehicle terminals (e.g., in-vehicle navigation terminals), and the like, as well as fixed terminals such as digital TVs, desktop computers, and the like. The electronic device illustrated in FIG. 5 is merely an example and should not impose any limitation on the functions and scope of use of the embodiments of the present disclosure.

As shown in FIG. 5, the electronic device 500 may include a processing device (e.g., a central processor, a graphics processor, etc.) 501 that may perform various appropriate actions and processes based on a program stored in a read-only memory (ROM) 502 or a program loaded from a storage device 508 into a random access memory (RAM) 503. Also stored in the RAM 503 are various programs and data necessary for the operation of the electronic device 500. The processing device 501, the ROM 502, and the RAM 503 are connected to each other via a bus 504. An edit/output (I/O) interface 505 is also connected to the bus 504.

Generally, the following devices may be connected to the I/O interface 505: an input device 506 including, for example, a touch screen, a touch pad, a keyboard, a mouse, a camera, a microphone, an accelerometer, a gyroscope, and the like; an output device 507 including, for example, a liquid crystal display (LCD), a loudspeaker, a vibrator, and the like; a storage device 508 including, for example, a magnetic tape, a hard disk, and the like; and a communication device 509. The communication device 509 may allow the electronic device 500 to communicate wirelessly or wiredly with other devices to exchange data. While FIG. 5 illustrates electronic device 500 with various devices, it should be understood that it is not required to implement or have all of the illustrated devices. More or fewer devices may alternatively be implemented or possessed.

In particular, according to embodiments of the present disclosure, the process described above with reference to the flowchart may be implemented as a computer software program. For example, embodiments of the present disclosure include a computer program product comprising a computer program carried on a non-transitory computer-readable medium, the computer program comprising program code for performing the method shown in the flowchart. In such embodiments, the computer program may be downloaded and installed from a network via a communication device 509, or from a storage device 508, or from a ROM 502. When this computer program is executed by the processing device 501, the above functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the method of data processing provided in the foregoing embodiments belong to the same inventive concept, and technical details not described in detail in this embodiment may refer to the foregoing embodiments, and this embodiment has the same beneficial effects as the foregoing embodiments.

A computer storage medium is provided by an embodiment of the present disclosure, wherein the computer-executable instructions, when executed by a computer processor, are configured to perform a method of data processing according to the method of data processing provided in the foregoing embodiments.

It is noted that the computer-readable medium described above in the present disclosure may be a computer-readable signaling medium or a computer-readable storage medium or any combination thereof. The computer-readable storage medium may, for example, be—but is not limited to—a system, apparatus, or device of electricity, magnetism, light, electromagnetism, infrared, or semiconductors, or any combination of the above. More specific examples of computer-readable storage media may include but are not limited to: electrical connections having one or more wires, portable computer disks, hard disks, random access memory (RAM), read-only memory (ROM), erasable programmable read-only memory (EPROM or flash memory), optical fibers, portable compact disk read-only memories (CD-ROM), optical storage devices, magnetic memory device, or any suitable combination of the foregoing. In the context of the present disclosure, a computer-readable storage medium may be any tangible medium containing or storing a program that may be used by or in combination with an instruction execution system, apparatus, or device. In the context of the present disclosure, a computer-readable signal medium may include a data signal propagated in a baseband or as part of a carrier that carries computer-readable program code. Such propagated data signals may take a variety of forms, including, but not limited to, electromagnetic signals, optical signals, or any suitable combination of the foregoing. The computer-readable signal medium may also be any computer-readable medium other than a computer-readable storage medium that sends, propagates, or transmits a program for use by, or in combination with, an instruction-executing system, apparatus, or device. The program code contained on the computer-readable medium may be transmitted using any suitable medium, including, but not limited to: wire, fiber optic cable, RF (radio frequency), etc., or any suitable combination of the foregoing.

In some implementations, the client, server may communicate with any currently known or future-developed network protocol such as HTTP (HyperText Transfer Protocol) and may be interconnected with digital data communications (e.g., communication networks) in any form or medium. Examples of communication networks include local area networks (“LANs”), wide area networks (“WANs”), inter-networks (e.g., the Internet), and end-to-end networks (e.g., ad hoc end-to-end networks), as well as any currently known or future developed networks.

The computer-readable medium may be contained in said electronic device; or it may stand alone and not be assembled into such electronic device.

The computer-readable medium carries one or more programs that, when said one or more programs are executed by the electronic device, enable the electronic device: receive a corpus to be processed; obtain a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and display the target prediction result.

Computer program code for performing the operations of the present disclosure may be written in one or more programming languages, or combinations thereof, including, but not limited to, object-oriented programming languages—such as Java, Smalltalk, C++—and conventional procedural programming languages—such as the “C” language or similar programming languages. The program code may be executed entirely on the user's computer, partially on the user's computer, as a stand-alone software package, partially on the user's computer and partially on a remote computer, or entirely on a remote computer or server. In the case involving a remote computer, the remote computer may be connected to the user computer via any kind of network—including a local area network (LAN) or a wide area network (WAN)—or, alternatively, it may be connected to an external computer (e.g., by using an Internet service provider to connect via the Internet).

The flowcharts and block diagrams in the accompanying drawings illustrate the architecture, functionality, and operation of systems, methods, and computer program products that may be implemented in accordance with various embodiments of the present disclosure. At this point, each block in the flowcharts or block diagrams may represent a module, program segment, or portion of code that contains one or more executable instructions for implementing a specified logical function. It should also be noted that in some implementations as replacements, the functions labeled in the boxes may also occur in a different order than those labeled in the accompanying drawings. For example, two consecutively represented blocks may actually be executed substantially in parallel, and they may sometimes be executed in reverse order, depending on the function involved. It is also noted that each of the blocks in the block diagrams and/or flowcharts, and combinations of the blocks in the block diagrams and/or flowcharts, may be implemented with a specialized hardware-based system that performs the specified function or operation, or may be implemented with a combination of specialized hardware and computer instructions.

The units described in the embodiments of the present disclosure may be implemented by way of software or by way of hardware. Wherein the name of the unit does not in some cases constitute a limitation of the unit itself, for example, the first obtaining unit may also be described as “a unit for obtaining at least two Internet Protocol addresses.”

The functions described above herein may be performed, at least in part, by one or more hardware logic components. For example, without limitation, example types of hardware logic components that may be used include: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media would include electrical connections based on one or more wires, portable computer disks, hard disks, random access memory (RAM), read-only memory (ROM), erasable programmable read-only memory (EPROM or flash memory), optical fibers, convenient compact disk read-only memory (CD-ROM), optical storage devices, magnetic storage devices, or any suitable combination of the foregoing. any suitable combination of the above.

According to one or more embodiments of the present disclosure, a method of data processing is provided by Example 1, comprising:
receiving a corpus to be processed;
obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
displaying the target prediction result.

According to one or more embodiments of the present disclosure, a method of Example 1 is provided by Example 2, further comprising:
optionally, before receiving the corpus to be processed, the method further comprises:
editing an original corpus; and
obtaining the corpus to be processed by marking a task identification for the original corpus, to cause the target diffusion language model to process the corpus to be processed based on the task identification.

According to one or more embodiments of the present disclosure, the method of Example 1 is provided by Example 3, further comprising:
optionally, the target diffusion language model is a multi-task type processing model, and the obtaining a target prediction result corresponding to the corpus to be processed by processing the corpus to be processed based on a target diffusion language model comprises:
identifying a task identification carried in the corpus to be processed based on the target diffusion language model to determine a task type corresponding to the corpus to be processed based on the task identification; and
processing the corpus to be processed based on the target diffusion language model to obtain the target prediction result matching the task type.

According to one or more embodiments of the present disclosure, the method of Example 1 is provided by Example 4, further comprising:
optionally, the method further includes: obtaining a training corpus corresponding to at least one task type; performing mask processing on the training corpus according to predetermined different mask rates to obtain a mask corpus corresponding to the training corpus; and determining the corpus samples based on the training corpus and the corresponding mask corpus.

According to one or more embodiments of the present disclosure, the method of Example 4 is provided by Example 5, further comprising:
optionally, the method further including: in response to the target diffusion language model being a multi-task type processing model, marking a corresponding task identification for the corpus sample to update the corpus sample,
wherein the task identification matches the task type.

According to one or more embodiments of the present disclosure, the method of Example 4 is provided by Example 6, further comprising:
optionally, after obtaining the corpus sample, the method further comprises: training to obtain the target diffusion language model; and wherein the training to obtain the target diffusion language model comprises: obtaining a pre-trained masked language model; and training the masked language model based on the corpus samples to obtain the target diffusion language model.

According to one or more embodiments of the present disclosure, the method of Example 6 is provided by Example 7, further comprising:
optionally, the training the masked language model based on the corpus samples to obtain the target diffusion language model comprises:
inputting the training corpus in the corpus samples into the masked language model to obtain an actual output corpus;
determining a loss value based on the actual output corpus and the corresponding mask corpus; and
adjusting model parameters in the masked language model based on the loss value with a training goal of convergence of a loss function in the masked language model, to obtain the target diffusion language model.

According to one or more embodiments of the present disclosure, a method of Example 1 is provided by Example 8, further comprising:

Optionally, the target prediction result comprising any of a translation result, an abstract result, a review result, or an error identification result corresponding to the corpus to be processed.

According to one or more embodiments of the present disclosure, an apparatus for data processing is provided by Example 9, comprising:
a corpus receiving module configured to receive a corpus to be processed;
a corpus processing module configured to obtain a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
a prediction result display module configured to display the target prediction result.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept. For example, a technical solution formed by interchanging the above-mentioned features with technical features having similar functions disclosed in the present disclosure (but not limited to).

Furthermore, although the operations are depicted using a particular order, this should not be construed as requiring that the operations be performed in the particular order shown or in a sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter defined in the appended claims is not necessarily limited to the particular features or actions described above. Rather, the particular features and actions described above are merely exemplary forms of implementing the claims.

I/We claim:

1. A method of data processing, comprising:
receiving a corpus to be processed;
obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
displaying the target prediction result.

2. The method of claim 1, wherein before receiving the corpus to be processed, the method further comprises:
editing an original corpus; and
obtaining the corpus to be processed by marking a task identification for the original corpus, to cause the target diffusion language model to process the corpus to be processed based on the task identification.

3. The method of claim 1, wherein the target diffusion language model is a multi-task type processing model, and the obtaining a target prediction result corresponding to the corpus to be processed by processing the corpus to be processed based on a target diffusion language model comprises:
identifying a task identification carried in the corpus to be processed based on the target diffusion language model to determine a task type corresponding to the corpus to be processed based on the task identification; and
processing the corpus to be processed based on the target diffusion language model to obtain the target prediction result matching the task type.

4. The method of claim 1, further comprising:
obtaining a training corpus corresponding to at least one task type;
performing mask processing on the training corpus according to predetermined different mask rates to obtain a mask corpus corresponding to the training corpus; and
determining the corpus samples based on the training corpus and the corresponding mask corpus.

5. The method of claim 4, further comprising:
in response to the target diffusion language model being a multi-task type processing model, marking a corresponding task identification for the corpus sample to update the corpus sample,
wherein the task identification matches the task type.

6. The method of claim 4, wherein after obtaining the corpus sample, the method further comprises:
training to obtain the target diffusion language model; and
wherein the training to obtain the target diffusion language model comprises:
obtaining a pre-trained masked language model; and
training the masked language model based on the corpus samples to obtain the target diffusion language model.

7. The method of claim 6, wherein the training the masked language model based on the corpus samples to obtain the target diffusion language model comprises:
inputting the training corpus in the corpus samples into the masked language model to obtain an actual output corpus;
determining a loss value based on the actual output corpus and the corresponding mask corpus; and
adjusting model parameters in the masked language model based on the loss value with a training goal of convergence of a loss function in the masked language model, to obtain the target diffusion language model.

8. The method of claim 1, wherein the target prediction result comprises any of a translation result, an abstract result, a review result, or an error identification result corresponding to the corpus to be processed.

9. An electronic device, comprising:
one or more processors; and
a storage device configured to store one or more programs which, when executed by the one or more processors, causes the one or more processors to implement acts comprising:
receiving a corpus to be processed;
obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
displaying the target prediction result.

10. The electronic device of claim 9, wherein before receiving the corpus to be processed, the acts further comprise:
editing an original corpus; and
obtaining the corpus to be processed by marking a task identification for the original corpus, to cause the target diffusion language model to process the corpus to be processed based on the task identification.

11. The electronic device of claim 9, wherein the target diffusion language model is a multi-task type processing model, and the obtaining a target prediction result corresponding to the corpus to be processed by processing the corpus to be processed based on a target diffusion language model comprises:
identifying a task identification carried in the corpus to be processed based on the target diffusion language model to determine a task type corresponding to the corpus to be processed based on the task identification; and
processing the corpus to be processed based on the target diffusion language model to obtain the target prediction result matching the task type.

12. The electronic device of claim 9, wherein the acts further comprise:
obtaining a training corpus corresponding to at least one task type;
performing mask processing on the training corpus according to predetermined different mask rates to obtain a mask corpus corresponding to the training corpus; and
determining the corpus samples based on the training corpus and the corresponding mask corpus.

13. The electronic device of claim 12, wherein the acts further comprise:
in response to the target diffusion language model being a multi-task type processing model, marking a corresponding task identification for the corpus sample to update the corpus sample,
wherein the task identification matches the task type.

14. The electronic device of claim 12, wherein after obtaining the corpus sample, the method further comprises:
training to obtain the target diffusion language model; and
wherein the training to obtain the target diffusion language model comprises:
obtaining a pre-trained masked language model; and
training the masked language model based on the corpus samples to obtain the target diffusion language model.

15. The electronic device of claim 14, wherein the training the masked language model based on the corpus samples to obtain the target diffusion language model comprises:
inputting the training corpus in the corpus samples into the masked language model to obtain an actual output corpus;
determining a loss value based on the actual output corpus and the corresponding mask corpus; and
adjusting model parameters in the masked language model based on the loss value with a training goal of convergence of a loss function in the masked language model, to obtain the target diffusion language model.

16. The electronic device of claim 9, wherein the target prediction result comprises any of a translation result, an abstract result, a review result, or an error identification result corresponding to the corpus to be processed.

17. A non-transitory storage medium comprising computer-executable instructions, wherein the computer-executable instructions, when executed by a computer processor, are configured to perform acts comprising:
receiving a corpus to be processed;
obtaining a target prediction result corresponding to the corpus to be processed by processing the corpus to be processed based on a target diffusion language model, wherein the target diffusion language model is obtained by training based on a plurality of corpus samples, and a mask corpora in the corpus samples corresponds to different mask rates; and
displaying the target prediction result.

18. The storage medium of claim 17, wherein before receiving the corpus to be processed, the acts further comprise:
editing an original corpus; and
obtaining the corpus to be processed by marking a task identification for the original corpus, to cause the target diffusion language model to process the corpus to be processed based on the task identification.

19. The storage medium of claim 17, wherein the target diffusion language model is a multi-task type processing model, and the obtaining a target prediction result corresponding to the corpus to be processed by processing the corpus to be processed based on a target diffusion language model comprises:
identifying a task identification carried in the corpus to be processed based on the target diffusion language model to determine a task type corresponding to the corpus to be processed based on the task identification; and
processing the corpus to be processed based on the target diffusion language model to obtain the target prediction result matching the task type.

20. The storage medium of claim 17, wherein the acts further comprise:
obtaining a training corpus corresponding to at least one task type;
performing mask processing on the training corpus according to predetermined different mask rates to obtain a mask corpus corresponding to the training corpus; and
determining the corpus samples based on the training corpus and the corresponding mask corpus.
